(19) United States
(12) Patent Application Publication
(10) Pub. No.: US 2025/0303552 A1
(43) Pub. Date: Oct. 2, 2025

(54) Robotic Confined Space Exploring System

(71) Applicant: Catmasters LLC, Houston, TX (US)

(72) Inventors: Emir Zahirovic, Houston, TX (US); Marc Angelo Rogato, Houston, TX (US)

(21) Appl. No.: 19/063,069

(22) Filed: Feb. 25, 2025

Related U.S. Application Data
(63) Continuation of application No. 29/978,057, filed on Dec. 11, 2024.
(60) Provisional application No. 63/573,333, filed on Apr. 2, 2024.

(51) Int. Cl. B25J 9/06; A47L 9/00; A47L 9/24; A47L 9/28; B25J 9/10; B25J 11/00; B25J 13/00; B25J 15/00; B25J 18/02; B25J 19/02; G01J 5/00; G01J 5/08; H04N 23/23; H04N 23/50

(52) U.S. Cl. CPC B25J 9/065; A47L 9/009; A47L 9/244; A47L 9/248; A47L 9/2815; A47L 9/2857; A47L 9/2868; B25J 9/1045; B25J 11/0085; B25J 13/006; B25J 15/0019; B25J 18/025; B25J 19/023; G01J 5/0859; H04N 23/555; G01J 2005/0077; H04N 23/23

(57) ABSTRACT

A robotic-controlled system, remotely controlled by a human, designed for navigating confined or hazardous spaces. The system minimizes human presence in confined spaces or hazardous work areas by providing the user with a robotic device capable of moving vertically and horizontally and rotating within a vessel. The system comprises an axial navigation segment, a radial navigation segment, a controller unit, and a user interface. The axial navigation segment secures to a top end of a support frame surrounding the vessel opening. The radial navigation segment is attached to a distal end of the axial navigation segment, and a tool head is attached to a distal end of the radial navigation segment. The controller unit electrically activates the motorized components of the system. By interacting with the user interface, the tool head can be precisely maneuvered in and around the confined space to reach the desired area of interest.

### FIELD OF THE INVENTION

The present invention relates generally to a confined space reactor explorer. More specifically, the present invention is a system that is designed to perform work, limit, and eliminate operators' physical presence in confined space and hazardous working zones.

### BACKGROUND OF THE INVENTION

Performing tasks in a confined space and hazardous zones requires careful planning, specialized equipment, and strict adherence to safety protocols to mitigate risks and ensure the well-being of personnel. Confined spaces, such as tanks, tunnels, reactors and storage bins, pose unique challenges due to limited entry and exit points. Additionally, restricted ventilation and potential hazards such as toxic gasses, engulfment, or mechanical hazards pose safety challenges. Hazardous zones, including areas with flammable substances, chemicals, or radiation, present additional risks to workers' health and safety. Within the current industry before entering a confined space or hazardous zone, workers must undergo comprehensive training on safety procedures, hazard recognition, and emergency response protocols. This includes conducting a thorough risk assessment to identify potential hazards and implementing control measures to minimize risks. Most workers are also equipped with appropriate personal protective equipment (PPE), such as respiratory protection, fall protection, and chemical-resistant clothing, to mitigate exposure to hazards.

When completing a task or exploring a confined or hazardous space, workers must continuously monitor environmental conditions, such as air quality, temperature, and atmospheric pressure, using specialized monitoring equipment. Communication systems, such as two-way radios or intercoms, should be in place to maintain contact with personnel inside the confined space or hazardous zone and facilitate coordination with the outside team. Working within these areas requires established emergency response plans which outline procedures for evacuation, rescue, and medical assistance in the event of an incident. Overall, performing tasks in confined spaces and hazardous zones requires careful planning, thorough training, and strict adherence to safety protocols to minimize risks and ensure the safety and well-being of workers. Collaboration between workers, supervisors, safety personnel, and emergency responders is essential to effectively manage risks and respond to potential emergencies in these challenging environments. An objective of the present invention is to provide users with a system that explores and performs tasks within a confined space or hazardous area. The present invention intends to provide users with a system that minimizes human presence in hazardous areas such as reactors. In order to accomplish this task, a preferred embodiment of the present invention comprises a support frame, an axial navigation segment, a radial navigation segment, and a controller unit. Thus, the present invention is a robotic system, remotely controlled by a human, for navigating confined or hazardous spaces.

### SUMMARY OF THE INVENTION

The present invention is a robotic system designed to assist with executing work within a confined space. The present invention seeks to provide users with a system designed to perform work, limit, and eliminate operators' physical presence in a confined space or a hazardous working zone. In order to accomplish this task, the present invention comprises a support frame that secures the present invention around a vessel, confined space, or hazardous zone. Further, the axial navigation segment moves vertically down into the vessel opening to reach areas within the confined space. The radial navigation segment allows the device to rotate 360° within the vessel. Further, the controller unit remotely controls both the axial navigation segment and the radial navigation segment. Thus, the present invention is a robotic system, remotely controlled by a human, for navigating confined or hazardous spaces.

### BRIEF DESCRIPTION OF THE DRAWINGS

FIG. 1 is a top-front-left perspective view of the present invention.

FIG. 2 is a top-front-right perspective view of the present invention.

FIG. 3 is a bottom-front-left perspective view of the present invention.

FIG. 4 is a front elevational view of the present invention.

FIG. 5 is a right-side elevational view of the present invention.

FIG. 6 is a magnified view taken from FIG. 2, showing the installation of the axial navigation segment and the winch.

FIG. 7 is magnified view taken from FIG. 4, showing the arrangement of components.

FIG. 8 is magnified view taken from FIG. 3, showing the arrangement of components.

FIG. 9 is a block diagram of the present invention, wherein thicker flowlines represent electrical connections between components and thinner flowlines represent electronic connections between components.

FIG. 10 is a block diagram of the present invention, in accordance with another embodiment, wherein thicker flowlines represent electrical connections between components, thinner flowlines represent electronic connections between components, and dashed flow lines indicate the components being communicably coupled.

### DETAIL DESCRIPTIONS OF THE INVENTION

All illustrations of the drawings are for the purpose of describing selected versions of the present invention and are not intended to limit the scope of the present invention.

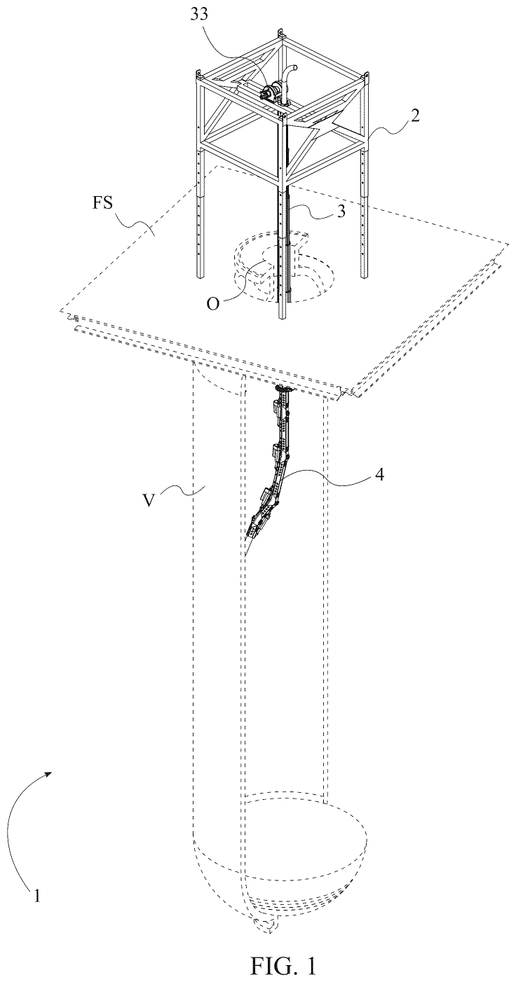

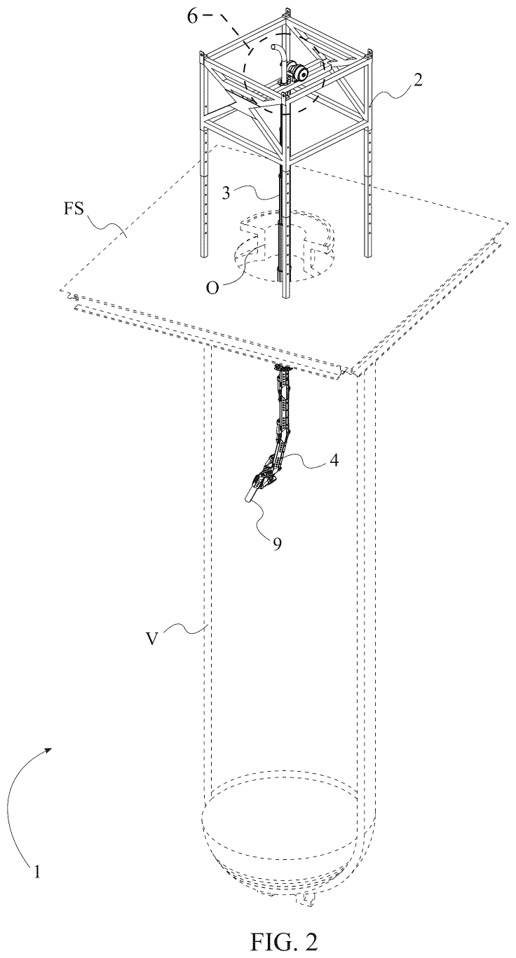

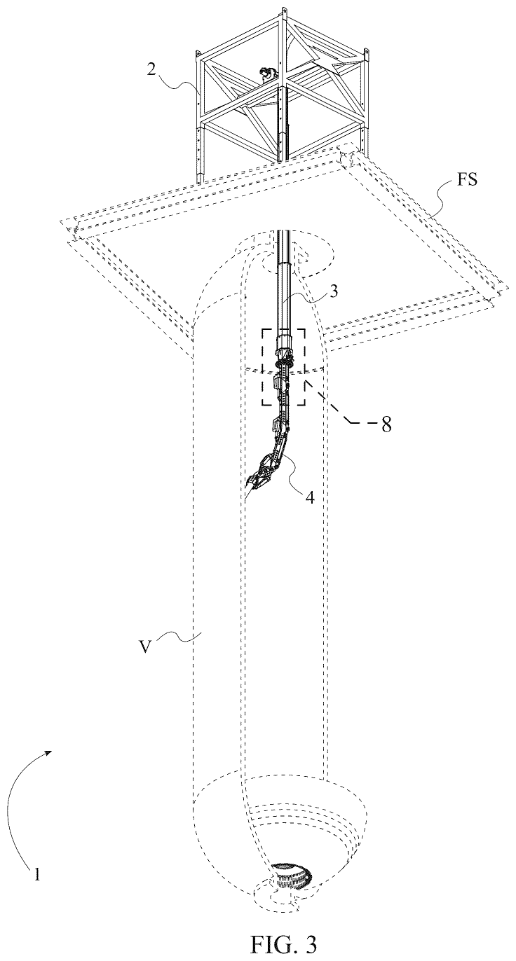

In reference to FIGS. 1-10, the present invention is a robotic-controlled system 1 designed to navigate a confined space or hazardous zone. An objective of the present invention is to minimize human presence in confined spaces or hazardous work areas by providing the user with a robotic-controlled system 1 capable of moving vertically and horizontally and rotating a full 360° to reach various locations within a confined space. To accomplish this objective, the present invention comprises a support frame 2, an axial navigation segment 3, a radial navigation segment 4, and a controller unit 5. The axial navigation segment is secured along a top end 20 of the support frame 2. A proximal end 40 of the radial navigation segment 4 is mechanically attached to a distal end 30 of the axial navigation segment 3. A tool head 43 is attached to a distal end of the radial navigation segment 4. The controller unit 5 is electrically connected to each of the motorized components installed throughout the system 1. The controller unit 5 is also electronically connected to a user interface 70. By interacting with the user interface 70, the tool head 43 can be precisely maneuvered in and around the confined space to reach the desired area of interest. In all, the present invention is a robotic-controlled system 1, remotely controlled by a human, for navigating confined or hazardous spaces.

The support frame 2 is a structure positioned around a vessel V, a tank, or any confined/hazardous space. The support frame 2 can be formed in various sizes, shapes, and structures based on design, user, and or manufacturing requirements. In a preferred embodiment, the support frame 2 is an adaptable and durable structure that is attached to the top end of a working vessel V, surrounding the vessel opening O. Alternatively, as seen throughout FIGS. 1-8, the support frame 2 can be attached to a floor structure FS surrounding the top end of the vessel V. The support frame 2 is preferably constructed from high-strength metal capable of bearing both external and internal loads. Specifically, the support frame 2 is capable of bearing loads of integral segments of the system attached to it as well as bearing loads of any material or hardware handled by the system.

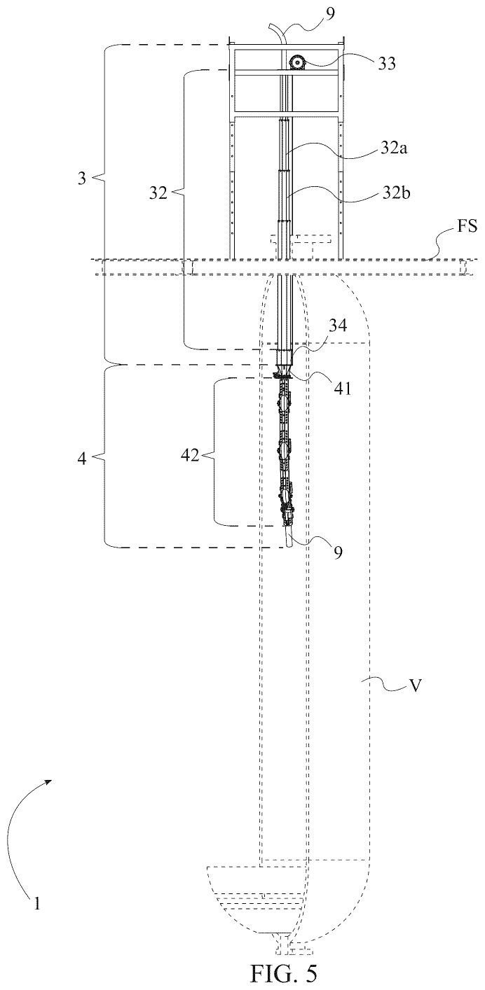

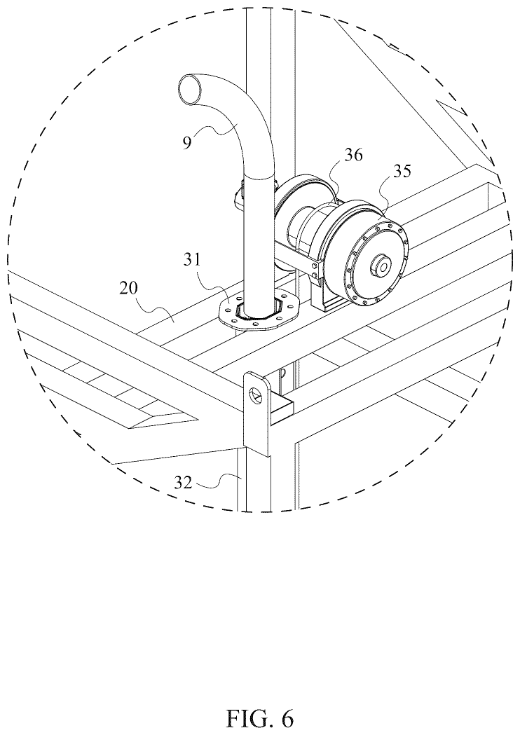

As best seen in FIGS. 5-6, a proximal end of the axial navigation segment 3 is attached to the top end 20 of the support frame 2, while a distal end 30 of the axial navigation segment 3 is attached to the radial navigation segment 4. This arrangement allows both the axial navigation segment 3 and the radial navigation segment 4 to extend downwards into the vessel opening O and reach the area of interest. The axial navigation segment 3 comprises a frame attachment 31, a plurality of telescoping sections 32, a motorized actuator 33, and an axial segment connector 34. The frame attachment 31 is a fastening/mounting structure that secures the axial navigation segment 3 to the support frame 2. The plurality of telescoping sections 32 is attached to the frame attachment 31 and extends downward into the vessel V.

As seen in FIG. 5, each telescoping section 32 is a rigid tube, wherein each inner telescoping section 32a is slightly smaller diameter-wise than the adjacent outer telescoping section 32b. This arrangement allows the plurality of telescoping sections 32 to telescope downwards and upwards. Preferably, each telescoping section 32 is constructed of metal, having an octagonal profile shape. When compared to a circular profile, the octagonal profile shape provides increased bending resistance and prevents the telescoping sections 32 from freely rotating. As will be explained in further detail below, the purpose of locking the rotational position of the telescoping sections 32 is to enable controlled rotational movements of the radial sections 42. Although the profile shape of each telescoping section 32 is preferably octagonal, it is understood that the profile shape is not limited and can be in the form of any suitable shape (including circular) based on design, user, and or manufacturing requirements.

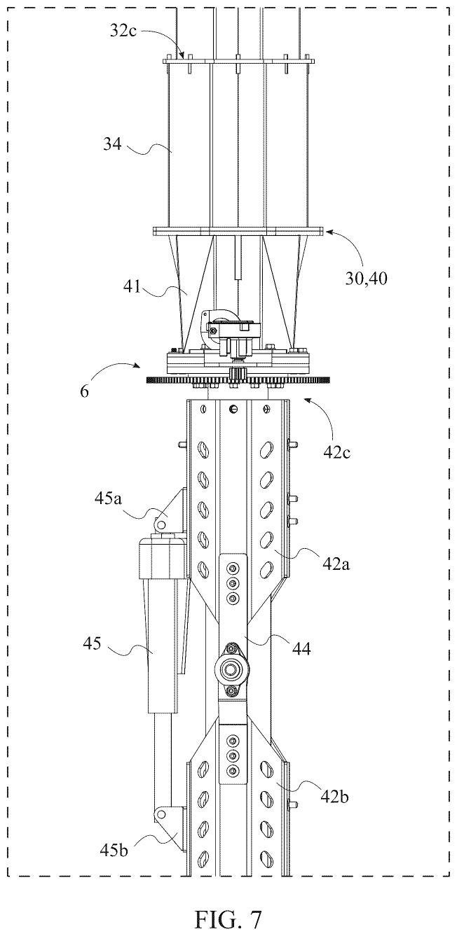

As seen in FIG. 7, the axial segment connector 34 is fixedly attached to a distal end 32c of the plurality of telescoping sections 32. The axial segment connector 34 is a fastening structure that secures the distal end 32c of the plurality of telescoping sections 32 to the proximal end of the radial navigation segment 4. More specifically, the axial segment connector 34 detachably connects to a radial segment connector 41. This arrangement enables both the axial navigation segment 3 and the radial navigation segment 4 to traverse upwards and downwards together, either near or within the area of interest of the vessel V.

The motorized actuator 33 is operably coupled to the plurality of telescoping sections 32, wherein operating the motorized actuator 33 governs telescoping movement of the plurality of telescoping sections 32. When activated, the motorized actuator 33 extends or retracts the plurality of telescoping sections 32. In general, the motorized actuator 33 can be any device designed to convert energy (electrical, hydraulic, or pneumatic) into mechanical force for the purpose of extending and retracting each of the plurality of telescoping sections 32. Such examples of the motorized actuator 33 can include but are not limited to a piston-driven actuator, a gear-driven actuator, a pulley-driven actuator, or any controllable device that converts rotational power from the motor to linear movement of the actuator. During use, the motorized actuator 33 moves the plurality of telescoping sections 32 upwards and downwards within the confined space of the vessel V. In one embodiment, as seen in FIG. 6, the motorized actuator 33 is in the form of a winch 35. In this embodiment, the winch 35 is fixedly attached to the top end 20 of the support frame 2, adjacent to the frame attachment 31. Here, the winch cable 36 traverses downward and attaches to the axial segment connector 34. When activated, the winch raises and lowers the axial segment connector 34, which in turn, extends and retracts the plurality of telescoping sections 32 within the confined space of the vessel. Preferably, the winch cable 36 is externally positioned, running along the outside of the telescoping sections 32. As will be explained in further detail below, this arrangement provides sufficient clearance to connect a vacuum hose V to the system.

In the preferred embodiment, the radial navigation segment 4 comprises a radial segment connector 41, a plurality of radial sections 42, a motorized gear system 6, and a tool head 43. As seen in FIG. 7, the radial segment connector 41 is positioned along a proximal end 40 of the radial navigation segment 4. From above, the radial segment connector 41 is detachably connected to the axial segment connector 34. From below, the radial segment connector 41 is operably coupled to the plurality of radial sections 42 via the motorized gear system 6, wherein operating the motorized gear system 6 governs the rotational movement of the plurality of radial sections 42 relative to the radial segment connector 41. The tool head 43 is adjacently connected to a distal end of the plurality of radial sections 42.

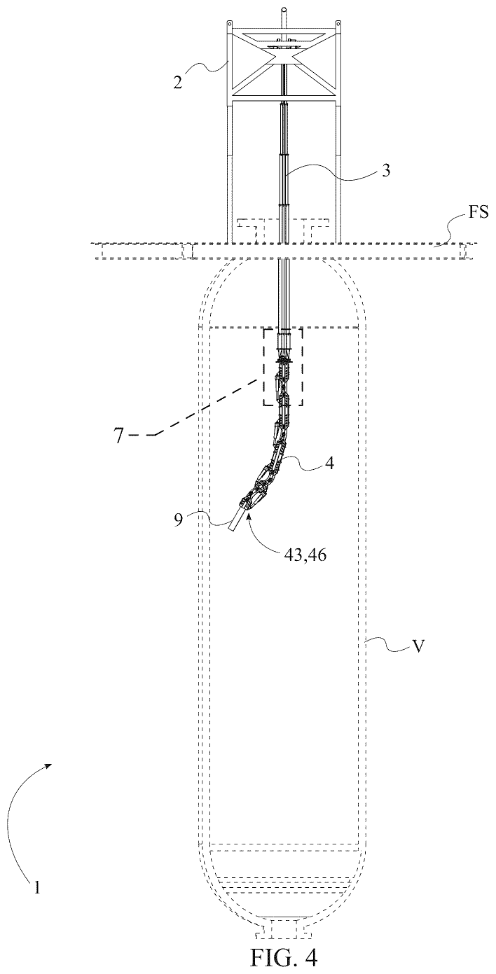

The tool head 43 is a type of mechanical adapter capable of securing various tools. This allows the user to perform various mechanical tasks while operating the present invention. For example, the tool head 43 can be configured to secure an electric screwdriver, allowing the user to fasten loose bolts and screws along a cover plate inside the vessel V. In the preferred embodiment, as seen in FIG. 4, the tool head 43 further comprises a hose attachment 46. In this embodiment, a vacuum hose 9 traverses through the hollow openings of both the axial navigation segment 3 and the radial navigation segment 4, and then detachably connects to the hose attachment 46. During use, the user can maneuver the vacuum hose 9 in and around the vessel V to suck up any waste and/or hazardous material that would otherwise be difficult and dangerous to reach by hand.

Once properly oriented, the tool head 43 is capable of reaching the interior walls of the vessel by articulating the plurality of radial sections 42. To perform this task, the radial navigation segment 4 further comprises a plurality of hinge couplers 44 and a plurality of linear actuators 45. As seen in FIG. 7, each radial section 42 is in the form of a rigid tube, and the plurality of hinge couplers 44 connect the rigid tubes to each other in series. More specifically, each of the plurality of hinge couplers 44 connects a trailing radial section 42a to a leading radial section 42b, thereby adjoining the radial sections 42 together in series to form a chain-like structure. All hinge couplers 44 are preferably oriented along the same plane (i.e., coplanar), and each hinge coupler 44 allows for one degree freedom. In this arrangement, the plurality of hinge couplers 44 delineates a plurality of pivot joints P distributed across the entire length of the plurality of radial sections 42. This allows the radial sections 42 to pivot through multiple pivot joints P. In turn, the plurality of radial sections 42 can articulate upward and radially outward to properly position the tool head 43 along the area of interest within the vessel V.

The plurality of linear actuators 45 is operably coupled to the plurality of hinge couplers 44, such that operating the plurality of linear actuators 45 governs the articulating movement of the plurality of radial sections 42 at the pivot joints P. More specifically, each linear actuator 45 is positioned orthogonal to each corresponding hinge coupler 44. A first end 45a of each linear actuator 45 is mounted to the trailing radial section 42a, while a second end 45b of each linear actuator 45 is mounted to the leading radial section 42b. When activated, the plurality of linear actuators 45 extend and retract, which in turn, rotates the hinge couplers 44 at the pivot joints P. During use, the user can remotely activate the linear actuators 45 independently of one another to move the tool head 43 into the desired position.

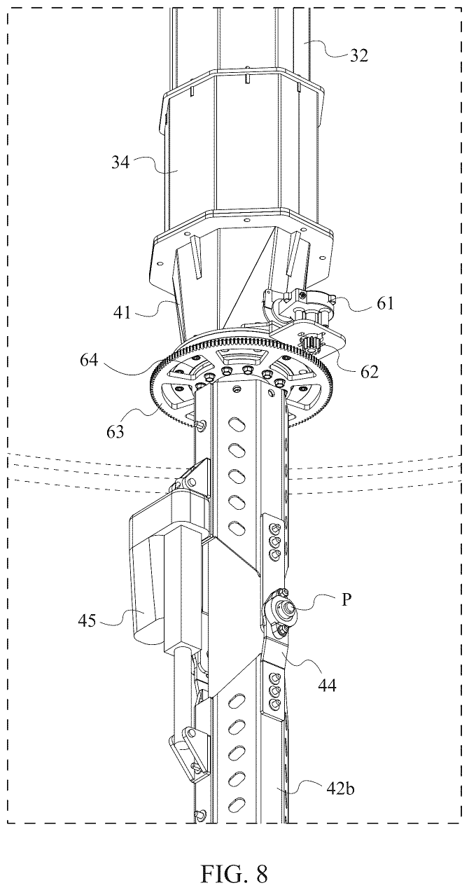

The motorized gear system 6 is capable of rotating the plurality of radial sections 42 within the vessel a full 360°, starting from −180° and rotating to +180°. Preferably, the motorized gear system 6 is in the form of a spur gear arrangement. To that end, the motorized gear system comprises a motor 61, a drive gear 62, a driven gear 63, and a roller bearing 64. As seen in FIG. 8, the motor 61 is fixedly attached to the radial segment connector 41. For optimal engagement between the drive gear 62 and driven gear 63, the motor 61 is preferably mounted to an offset bracket extending radially outward from the radial segment connector 41. However, in other embodiments, the motor 61 can be positioned at any suitable location along the radial segment connector 41 based on design, user, and/or manufacturing requirements. The drive gear 62 is fixedly attached to the output shaft of the motor 61 and is also operably connected to the driven gear 63. From the bottom side, the driven gear 63 is axially aligned and fixedly attached to the proximal end 42c of the plurality of radial sections 42. This arrangement allows the driven gear 63 and the plurality of radial sections 42 to rotate together in unison.

From the top side, the driven gear 63 is rotatably connected to the radial segment connector 41 via the roller bearing 64. Here, the roller bearing 64 is positioned in between the driven gear 63 and the radial segment connector 41. When the motor 61 is activated, the drive gear 62 engages with the driven gear 63 to rotate the plurality of radial sections 42 relative to the radial segment connector 41. It is understood that the motorized gear system 6 is not limited to a spur gear arrangement. In other embodiments, the motorized gear system 6 can take the form of any suitable gear arrangement based on design, user, and/or manufacturing requirements.

When working in tandem, all motorized components described above enable the user to precisely position the tool head 43 at the desired area of interest within the vessel V. First, the user lowers the tool head 43 to the proper depth by activating the motorized actuator 33 of the axial segment connector 3. Second, the user rotates the toolhead 43 to face the general area of interest by activating the motorized gear system 6 of the radial navigation segment 4. And last, the user extends the tool head 43 radially outward to reach the area of interest by activating the plurality of linear actuators 45.

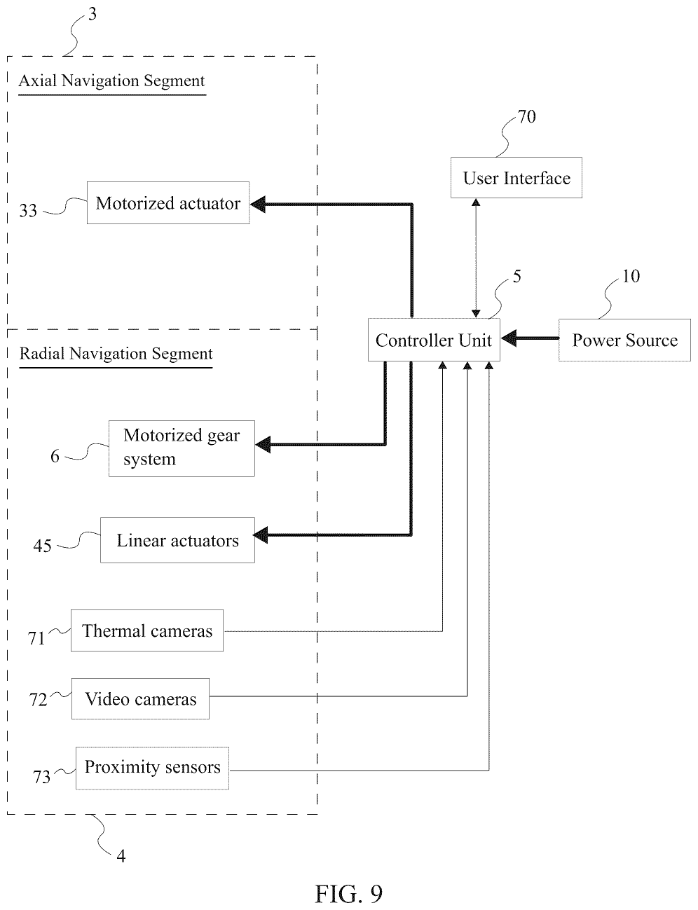

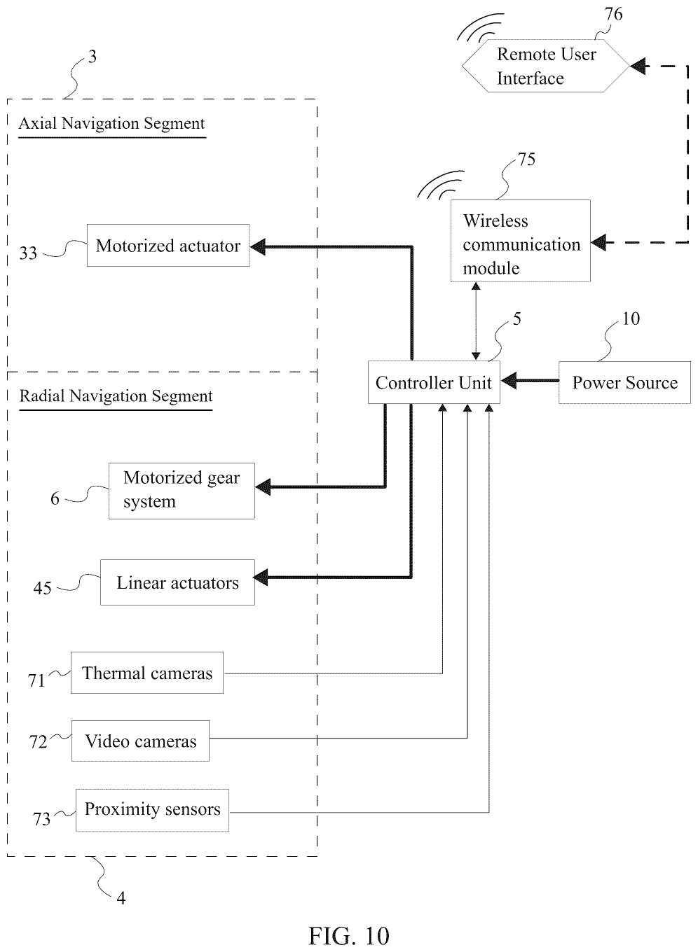

In reference to FIGS. 9-10, the controller unit 5 is a computing system designed to manage the operation of all electrical components within the present invention. Specifically, the controller unit 5 controls all motorized components installed throughout the axial navigation segment 3 and the radial navigation segment 4. The controller unit 5 is communicably connected to a user interface 70 on a corresponding display device. The user interface 70 allows the user to interact with the present invention by sending various commands to the controller unit 5. In turn, the controller unit 5 executes each command. The commands include but are not limited to linear movements along the X, Y, and Z-axis, as well as rotational movements about the Z-axis. Here, the user interface 70 can be a digital or analog control interface. Through the user interface 70, the user can directly control the positioning of the tool head 43 by activating the motorized components individually.

In the preferred embodiment, as seen in FIG. 9, the controller unit 5 receives and distributes electrical power from an external power source 10. Stated another way, the power source 10 is electrically connected to the controller unit 5. Thereafter, the controller unit 5 distributes the electrical power to each of the motorized components via commands received by the user interface 70. More specifically, the user interface 70 is electronically connected to the controller unit 5, such that operating the user interface 70 governs controlled movement of the tool head 43 within the vessel. Each of the motorized actuator 33, the motorized gear system 6, and the plurality of linear actuators 45 are electrically connected to the controller unit 5. Preferably, the controller unit 5 runs an algorithm that regulates electrical power delivered to each of the motorized components, thereby ensuring the electrical load placed on any individual motorized component does not exceed its maximum load requirement.

In another embodiment, as seen in FIG. 10, the present invention further comprises a wireless communication module 75 and a remote user interface 76. In this embodiment, the user can wirelessly transmit commands to the controller unit 5 via the remote user interface 76 (e.g., mobile app, tablet, remote control device). The commands include but are not limited to linear movements along the X, Y, and Z-axis and rotational movements about the Z-axis. Here, the wireless communication module 75 is electronically connected to the controller unit 5. The wireless communication module 75 comprises Wi-Fi and Bluetooth capabilities, such that the wireless communication module 75 may communicate with the remote user interface 76 via wireless data transmission protocols. Example standards of what the wireless communication module 75 is capable of using includes, but are not limited to, Bluetooth, WI-FI, GSM, CDMA, ZigBee, etc.

To properly navigate in and around the vessel, the present invention further comprises a plurality of electronic peripherals. More specifically, the present invention further comprises a plurality of thermal cameras 71, a plurality of video cameras 72, and a plurality of proximity sensors 73. The plurality of thermal cameras 71 is designed to monitor the temperature within the area of interest. Each of the plurality of thermal cameras 71 are mounted along the radial navigation segment 4 and are each electronically connected to the controller unit 5. In this arrangement, the temperature data received by the thermal cameras 71 are transmitted to the user interface 70 in real-time via the controller unit 5. The plurality of video cameras 72 is also mounted along the radial navigation segment 4 and are each electronically connected to the controller unit 5. Each of the plurality of video cameras 72 capture live video footage and stream the video footage to the user interface 70 via the controller unit 5. This arrangement allows the user to visually see where the tool head 43 is located in relation to the area of interest. Lastly, each of the plurality of proximity sensors 73 are also mounted along the radial navigation segment 4 and are each electronically connected to the controller unit 5. The proximity data received by each of the proximity sensors 73 is transmitted to the controller unit 5 for processing. The plurality of proximity sensors 73 is designed to ensure the present invention does not contact or run into any undesired surfaces or items within the area of interest.

With all the components working in tandem, it can be seen that the present invention is a robotic system, remotely controlled by a human, for navigating confined or hazardous spaces. Although the invention has been explained in relation to its preferred embodiment, it is to be understood that many other possible modifications and variations can be made without departing from the spirit and scope of the invention.

What is claimed is:

1. A robotic system for navigating a confined space, the robotic system comprising:
a support frame;
an axial navigation segment;
a radial navigation segment;
the support frame being positioned over the opening of a vessel;
the axial navigation segment being attached to the support frame;
the axial navigation segment extending into the opening of the vessel;
the radial navigation segment being attached to a distal end of the axial navigation segment;
the axial navigation segment comprising a plurality of telescoping sections and a motorized actuator;
the motorized actuator being operably coupled to the plurality of telescoping sections, wherein operating the motorized actuator governs telescoping movement of the plurality of telescoping sections;
the radial navigation segment comprising a radial segment connector, a plurality of radial sections, a motorized gear system, and a tool head;
the radial segment connector being operably coupled to the plurality of radial sections via the motorized gear system, wherein operating the motorized gear system governs rotational movement of the plurality of radial sections relative to the radial segment connector; and
the tool head being connected to a distal end of the plurality of radial sections.

2. The robotic system as claimed in claim 1 comprising:
the radial navigation segment further comprising a plurality of hinge couplers and a plurality of linear actuators;
each of the radial sections being operably connected together in series via the plurality of hinge couplers;
the plurality of hinge couplers delineating a plurality of pivot joints; and
the plurality of linear actuators being operably coupled to the plurality of hinge couplers, wherein operating the plurality of linear actuators governs articulating movement of the plurality of radial sections at the pivot joints.

3. The robotic system as claimed in claim 2 comprising:
each linear actuator being positioned orthogonal to each corresponding hinge coupler;
a first end of each linear actuator being mounted to a trailing radial section;
a second end of each linear actuator being mounted to a leading radial section; and
each linear actuator capable of rotating each corresponding hinge coupler at the pivot joint when the plurality of linear actuators is activated.

4. The robotic system as claimed in claim 1 comprising:
the motorized gear system comprising a motor, a drive gear, a driven gear, and a roller bearing;
the motor being fixedly attached to the radial segment connector;
the driven gear being fixedly attached to a proximal end of the plurality of radial sections;
the driven gear being rotatably connected to the radial segment connector via the roller bearing; and
the plurality of radial sections being operably connected to the motor, wherein the plurality of radial sections rotates relative to the radial segment connector when the motor is activated.

5. The robotic system as claimed in claim 1 comprising:
a controller unit;
a power source;
a user interface;
the power source being electrically connected to the controller unit;
the controller unit being electrically connected to each of the motorized actuator, the motorized gear system, and the plurality of linear actuators; and
the user interface being electronically connected to the controller unit, wherein operating the user interface governs controlled movement of the tool head within the vessel.

6. The robotic system as claimed in claim 5 comprising:
a plurality of video cameras;
a plurality of proximity sensors;
the plurality of video cameras and the plurality of proximity sensors each being mounted along the radial navigation segment; and
the plurality of video cameras and the plurality of proximity sensors each being electronically connected to the controller unit.

7. The robotic system as claimed in claim 6 comprising:
a plurality of thermal cameras;
the plurality of thermal cameras being mounted along the radial navigation segment; and
the plurality of thermal cameras being electronically connected to the controller unit.

8. The robotic system as claimed in claim 1 comprising:
the motorized actuator being in the form of a winch; and
the winch being fixedly attached to a top end of the support frame.

9. The robotic system as claimed in claim 1 comprising:
a vacuum hose;
the tool head further comprising a hose attachment; and
the vacuum hose traversing through the axial navigation segment, through the radial navigation segment, and detachably connecting to the hose attachment.

10. A robotic system for navigating a confined space, the robotic system comprising:
a support frame;
an axial navigation segment;
a radial navigation segment;
a controller unit;
a power source;
a user interface;
the support frame being positioned over the opening of a vessel;
the axial navigation segment being attached to the support frame;
the axial navigation segment extending into the opening of the vessel;
the radial navigation segment being attached to a distal end of the axial navigation segment;
the axial navigation segment comprising a plurality of telescoping sections and a motorized actuator;
the motorized actuator being operably coupled to the plurality of telescoping sections, wherein operating the motorized actuator governs telescoping movement of the plurality of telescoping sections;
the radial navigation segment comprising a radial segment connector, a plurality of radial sections, a motorized gear system, a tool head, a plurality of hinge couplers, and a plurality of linear actuators;
the radial segment connector being operably coupled to the plurality of radial sections via the motorized gear system, wherein operating the motorized gear system governs rotational movement of the plurality of radial sections relative to the radial segment connector;
the tool head being connected to a distal end of the plurality of radial sections;
each of the radial sections being operably connected together in series via the plurality of hinge couplers;
the plurality of hinge couplers delineating a plurality of pivot joints; and
the plurality of linear actuators being operably coupled to the plurality of hinge couplers, wherein operating the plurality of linear actuators governs articulating movement of the plurality of radial sections at the pivot joints.

11. The robotic system as claimed in claim 10 comprising:
each linear actuator being positioned orthogonal to each corresponding hinge coupler;
a first end of each linear actuator being mounted to a trailing radial section;
a second end of each linear actuator being mounted to a leading radial section; and
each linear actuator capable of rotating each corresponding hinge coupler at the pivot joint when the plurality of linear actuators is activated.

12. The robotic system as claimed in claim 10 comprising:
the motorized gear system comprising a motor, a drive gear, a driven gear, and a roller bearing;
the motor being fixedly attached to the radial segment connector;
the driven gear being fixedly attached to a proximal end of the plurality of radial sections;
the driven gear being rotatably connected to the radial segment connector via the roller bearing; and
the plurality of radial sections being operably connected to the motor, wherein the plurality of radial sections rotates relative to the radial segment connector when the motor is activated.

13. The robotic system as claimed in claim 10 comprising:
a plurality of thermal cameras;
a plurality of video cameras;
a plurality of proximity sensors;
the plurality of thermal cameras, the plurality of video cameras, and the plurality of proximity sensors each being mounted along the radial navigation segment;
the power source being electrically connected to the controller unit;
the controller unit being electrically connected to each of the motorized actuator, the motorized gear system, and the plurality of linear actuators;
the plurality of thermal cameras, the plurality of video cameras, and the plurality of proximity sensors each being electronically connected to the controller unit; and
the user interface being electronically connected to the controller unit, wherein operating the user interface governs controlled movement of the tool head within the vessel.

14. The robotic system as claimed in claim 10 comprising:
the motorized actuator being in the form of a winch; and
the winch being fixedly attached to a top end of the support frame.

15. The robotic system as claimed in claim 10 comprising:
a vacuum hose;
the tool head further comprising a hose attachment; and
the vacuum hose traversing through the axial navigation segment, through the radial navigation segment, and detachably connecting to the hose attachment.

16. A robotic system for navigating a confined space, the robotic system comprising:
a support frame;
an axial navigation segment;
a radial navigation segment;
a controller unit;
a power source;
a user interface;
a vacuum hose;
the support frame being positioned over the opening of a vessel;
the axial navigation segment being attached to the support frame;
the axial navigation segment extending into the opening of the vessel;
the radial navigation segment being attached to a distal end of the axial navigation segment;
the axial navigation segment comprising a plurality of telescoping sections and a motorized actuator;
the motorized actuator being operably coupled to the plurality of telescoping sections, wherein operating the motorized actuator governs telescoping movement of the plurality of telescoping sections;
the radial navigation segment comprising a radial segment connector, a plurality of radial sections, a motorized gear system, a tool head, a plurality of hinge couplers, and a plurality of linear actuators;
the radial segment connector being operably coupled to the plurality of radial sections via the motorized gear system, wherein operating the motorized gear system governs rotational movement of the plurality of radial sections relative to the radial segment connector;
the tool head being connected to a distal end of the plurality of radial sections;
each of the radial sections being operably connected together in series via the plurality of hinge couplers;
the plurality of hinge couplers delineating a plurality of pivot joints;
the plurality of linear actuators being operably coupled to the plurality of hinge couplers, wherein operating the plurality of linear actuators governs articulating movement of the plurality of radial sections at the pivot joints;
the tool head further comprising a hose attachment; and
the vacuum hose traversing through the axial navigation segment, through the radial navigation segment, and detachably connecting to the hose attachment.

17. The robotic system as claimed in claim 16 comprising:
each linear actuator being positioned orthogonal to each corresponding hinge coupler;
a first end of each linear actuator being mounted to a trailing radial section;
a second end of each linear actuator being mounted to a leading radial section; and
each linear actuator capable of rotating each corresponding hinge coupler at the pivot joint when the plurality of linear actuators is activated.

18. The robotic system as claimed in claim 16 comprising:
the motorized gear system comprising a motor, a drive gear, a driven gear, and a roller bearing;
the motor being fixedly attached to the radial segment connector;
the driven gear being fixedly attached to a proximal end of the plurality of radial sections;
the driven gear being rotatably connected to the radial segment connector via the roller bearing; and
the plurality of radial sections being operably connected to the motor, wherein the plurality of radial sections rotates relative to the radial segment connector when the motor is activated.

19. The robotic system as claimed in claim 16 comprising:
a plurality of thermal cameras;
a plurality of video cameras;
a plurality of proximity sensors;
the plurality of thermal cameras, the plurality of video cameras, and the plurality of proximity sensors each being mounted along the radial navigation segment;
the power source being electrically connected to the controller unit;
the controller unit being electrically connected to each of the motorized actuator, the motorized gear system, and the plurality of linear actuators;
the plurality of thermal cameras, the plurality of video cameras, and the plurality of proximity sensors each being electronically connected to the controller unit; and
the user interface being electronically connected to the controller unit, wherein operating the user interface governs controlled movement of the tool head within the vessel.

20. The robotic system as claimed in claim 16 comprising:
the motorized actuator being in the form of a winch; and
the winch being fixedly attached to a top end of the support frame.
